(19) United States
(12) Patent Application Publication
(10) Pub. No.: US 2005/0127588 A1
(43) Pub. Date: Jun. 16, 2005

(54) Microtechnically produced swiveling platform with magnetic drive and stop positions

(76) Inventor: Hans-Heinrich Gatzen, Isernhagen (DE)

Correspondence Address: Charles N.J. Ruggiero;Ohlandt Greeley Ruggiero & Perle, One Landmark Square, 10th Floor, Stamford, CT, 06901-2682, US

(21) Appl. No.: 10/503,118

(22) PCT Filed: Jan. 31, 2003
(86) PCT No.: PCT/EP03/00994

(30) Foreign Application Priority Data
Jan. 31, 2002 (DE) 102 04 491.0

(51) Int. Cl. B25B 11/00

(52) U.S. Cl. 269/8

(57) ABSTRACT

A swiveling platform, particularly microtechnically produced, is provided. The platform has at least one degree of freedom. The platform is bistably tiltable around at least one axis.

The invention concerns a microtechnically fabricated swiveling platform, particularly with one degree freedom, which in this example is tiltable around at least one axis.

It is known to operate micro-electromechanical systems by forces caused by means of electric or electromagnetic fields, as well as thermally or piezoelectrically. In general, the fields or tensions for maintaining a position of a moveable part of such a device have to be maintained. However, quite often it is desirable to switch back and forth between several positions without having to maintain the driving currents or voltages For this purpose, bistable actuators are known from the state of the art. In general, thereby it is taken advantage of the bistable behavior of the energy stored in flexible segments. To switch such elements between the stable positions, the segments are appropriately displaced, whereby they are latching in the alternative stable position.

Among others, known devices utilize the so-called “Young-Mechanism”, the Linear Displacement Bistable Micromechanism, LDBM, or mechanisms of the snap lock type. The solutions of the problem to create a bistable actuator, however, are mechanically very expensive and therefore microtechnically difficult to realize.

Therefore, it is an object of the invention to provide a micromechanical device, which avoids the above mentioned disadvantages or, respectively, is relatively simple to manufacture.

This object is already solved in a surprisingly simple way by means of a swiveling, particularly microtechnically fabricated platform according to claim 1. Advantageous developments are subject of the dependent claims.

Actuation is preferably performed electromagnetically. The magnetic system is designed in a way, that the platform is held in its end position by the magnetic force of at least one hard magnet, resulting in a detent position. This way, current is only required during switching and the detent position may be maintained without a driving current. This principle of a bistable latching of a movable device may be fabricated much more easily than may be accomplished by a bistability through flexible elements. Furthermore, this invention allows the realization of bistable swiveling platforms exhibiting not only two but a multitude of stable detent positions.

An additional stable position may be defined furthermore through the influence of restoring forces of the platform suspension, where the restoring forces amount to zero or have minimal value.

The invention is described hereafter in detail by means of the attached drawings and with respect to preferred examples. It is depicted by:

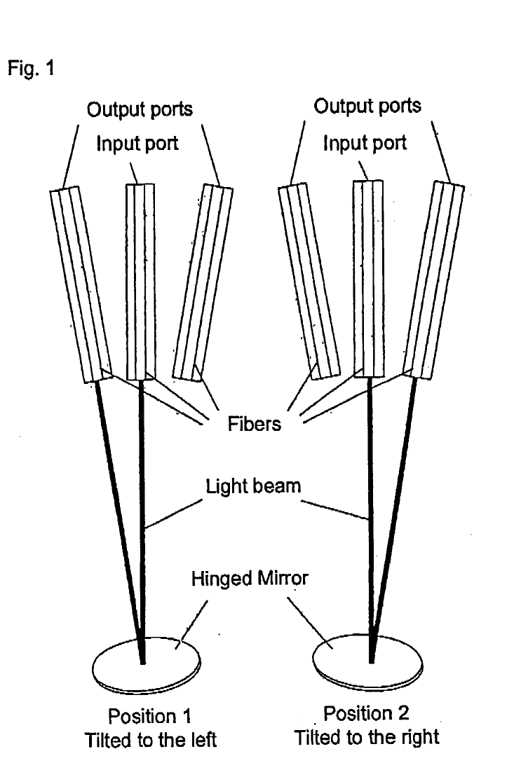

FIGS. 1a and 1b: the use of the swiveling platform as a mirror system for optical data communication.

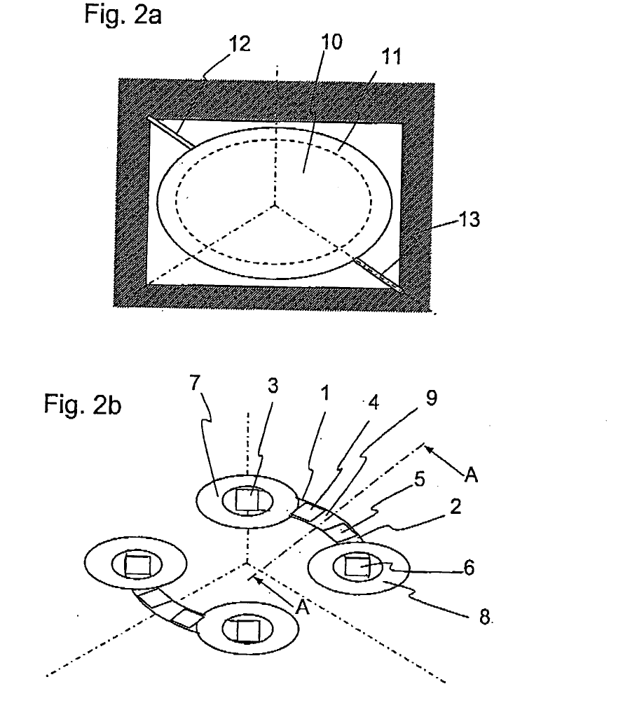

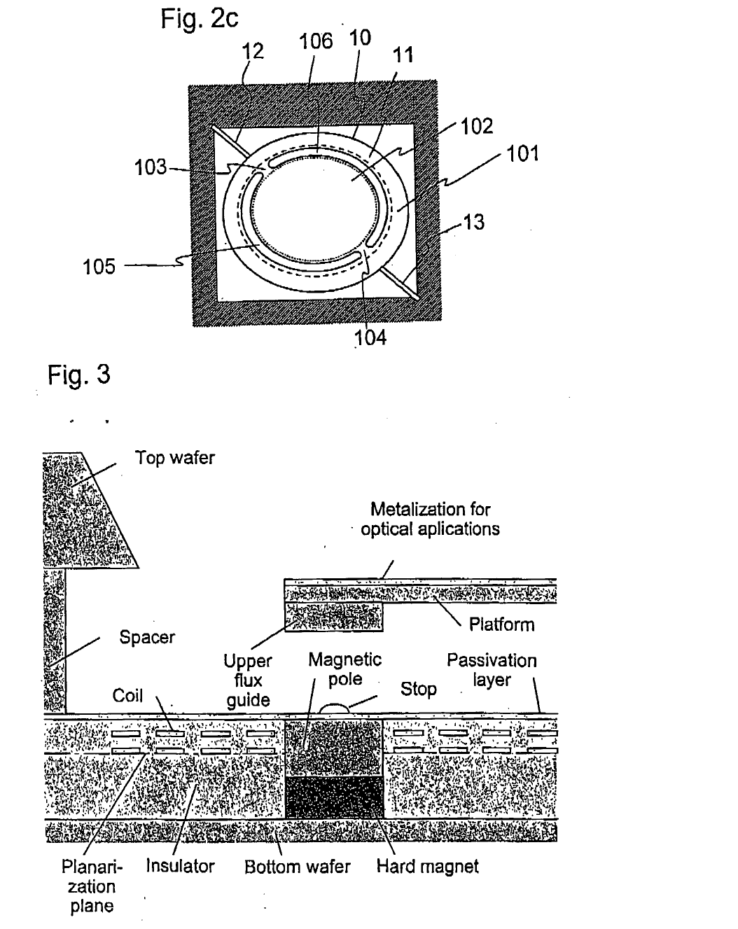

FIGS. 2a and b: the basic principle of the microtechnically fabricated electromagnetic actuation, with FIG. 2a depicting a schematic view of the swivelling platform and FIG. 2b a view of an active part,

FIG. 2c: a top view of an example of the swivelling platform.

FIG. 3: an approach to an assembly technique with the whole system built up on two wafers, which are connected by appropriate assembly technique.

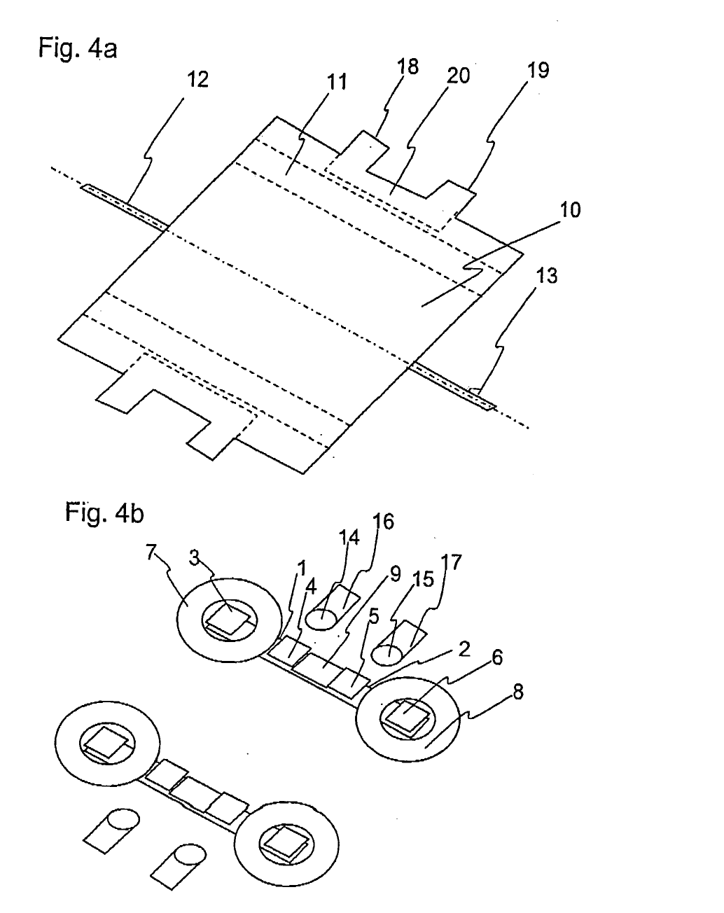

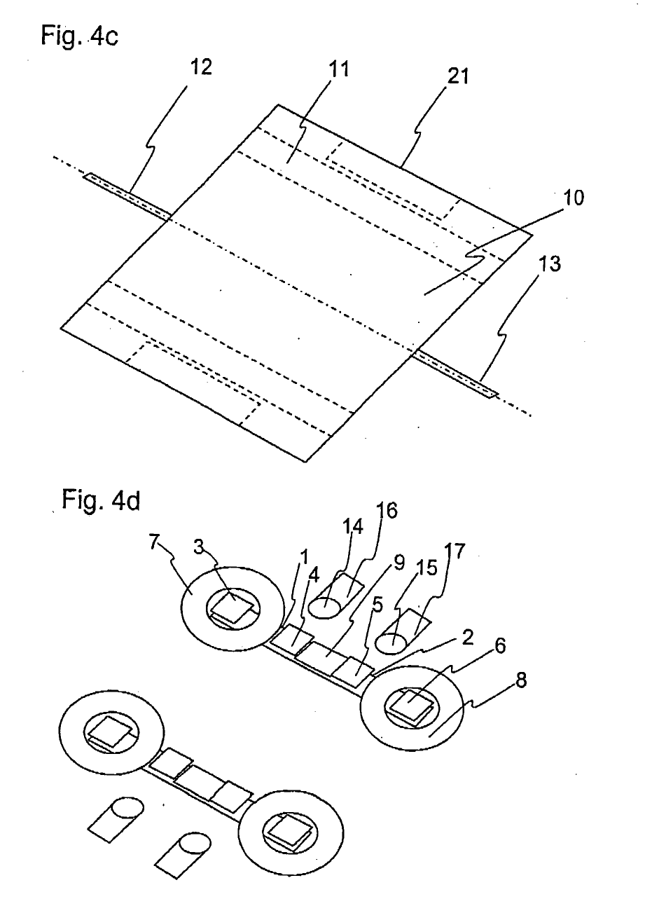

FIGS. 4a and 4b: a micro relay embodiment of the invention, and

FIGS. 4c and 4d: a modification of the embodiment shown in FIGS. 4a and 4b.

### DETAILED DESCRIPTION OF PREFERRED EMBODIMENTS

The microtechnically fabricated electromagnetic drive comprises an active part and a passive part. The active part contains a magnetic flux guide system with coils and the passive part comprises a magnetic flux closure.

FIG. 2b depicts a schematic view of the active part of a magnet system of the platform according to the invention with C-shaped magnetic legs, whereby each magnetic leg forms a yoke and two poles, flat spiral coils, and hard magnets.

For each of the end location tilting positions or end location detent positions, an active part is provided, whereby the example shown in FIGS. 2a and 2b exhibits two end location tilting positions or end location detent positions. The active part for a tilting motion to the right comprises yokes 1 and 2, poles 3, 4, 5, and 6, coils 7 and 8, and a hard magnet 9.

The passive part is located on the bottom part of the hinged plate 10 as shown schematically in FIG. 2a and includes a flux closure 11. The swiveling platform is suspended on two torsion springs 12 and 13. The swiveling platform shown in FIG. 2a and the active part of the magnet system depicted in FIG. 2b are positioned to each other in a way that the magnetic field created by the active part exerts magnetic forces on the flux closure 11 located on the swiveling platform 10 so that the swiveling platform 10 may be swiveled by means of a change of the magnetic field acting thereon.

Due to the restoring forces of the torsion springs serving as suspensions for the swiveling platform 10 an additional stable position can be defined and adjusted, in which the torsion springs are relaxed, or, respectively, in which the restoring forces are minimal by module.

For the use of the swiveling platform serving as an optical switch according to one embodiment of the invention, it is of particular importance that the mirror surface is absolutely plain. This is supported by the facts that the mirror is fabricated round or polygonally shaped and that the flux closure forms a ring. This way, a drumhead-like stiffening is formed, supporting the evenness and in particular the solidity or stiffness of the mirror.

In accordance with a further embodiment of the invention, the swiveling platform comprises two areas connected by two links or separated from each other by at least one gap, whereby a first area contains the flux closure. The second area may be coated with a metallized reflecting layer or at least may contain a reflective area. Such a variant of a swiveling platform is depicted in FIG. 2c. Similar to the embodiment shown in FIG. 2a, the swiveling platform 10 is held by the two torsion springs 12 and 13.

According to the embodiment shown in FIG. 2c, the swiveling platform 10 is subdivided into two areas 101 and 102. The first area 101 annularly encompasses the second area 102 and contains the magnetic flux closure 11. The second area 102 may favorably comprise a metallized reflecting layer or a reflective area, so that the platform may be used as an optical switch. The two areas are mechanically decoupled to a large extent due to interruptions, whereby the interruptions exemplary are ring segment shaped gaps 105 and 106. An interconnection of the two areas 101 and 102 is ensued by linking sections 103 and 104 between the gaps 105 and 106. This embodiment of the invention is particularly insensitive to temperature changes. By coupling the areas 101 and 102 through web shaped links, any influence due to a bimetal effect caused by the different thermal expansion factors of the substrate material of the hinged plate and the material of the magnetic flux guide is largely avoided. Although there is still a deformation of the outer area 101 it practically does not affect the inner part which is for instance advantageous for the optical properties of an embodiment serving as an optical switch. On the other hand, the mechanical coupling through the links 103 and 104 is sufficient for carrying the inner area 102 along with the outer area.

Preferably, the linking sections 103 and 104 are located on opposite positions of area 101 to achieve high mechanical stability and at the same time a well uncoupling from any deformations occurring in area 101. Preferably the sections 103 and 104 are located along the imaginary connecting line between the torsion springs 12 and 13.

Energizing the right half of the active part by driving coils 7 and 8 with a current results in an attractive force at the yoke, resulting in a tilt.

The hard magnet located between the C-shaped yoke pole systems causes a magnetic holding force influencing the magnetic flux closure within the hinged plate, even with the coil current switched off. Alternatively, this may be accomplished by choosing a hard magnetic flux closure rather than a soft magnetic one.

For fabricating the magnet systems, microtechnical fabrication processes are employed. These are characterized by building up the desired structures by means of a suitable combination of deposition, etching and, if necessary, doping technologies and photolithography. Thereby, the systems are batch fabricated.

Taking reference to FIG. 3, this figure shows an approach to mounting techniques. The whole system is fabricated on two wafers, which are then connected by appropriate mounting technique. In the lower substrate in FIG. 3, which will also be denoted as “bottom wafer” hereinafter, the active magnet system is located. The upper wafer as shown in FIG. 3 will be denoted as “top wafer” in the following. This allocation, as the one previously shown in FIGS. 2a and 2b for the active system, is not determining a position in space, it merely serves for a better understanding of the description and of the relative position of the components to each other. The top wafer contains the swiveling platform with the flux closure.

Further Possibilities for Use of the Device According to the Invention:

More than two detent positions may be accomplished by equipping the swiveling platform with a gimbal and localizing a magnet system at desired detent position.

For instance, with four magnet systems thus the following detent positions are achieved:
(1) Tilted up
(2) Tilted right
(3) Tilted down
(4) Tilted left

A further application is offered by using the bistable platform for building up a micro relay. The respective bistable position may be called a detent position, in which the platform remains in locked position, which means that without external forces or even under the influence of small external forces it does not change its position. Particularly the swiveling platform embodiment according to the invention forming a micro relay preferably comprises at least one device for closing and opening a contact.

In the embodiment as a micromechanical relay, the swiveling platform is equipped with contact fingers or contact rails, which, as part of the device for closing or opening of a contact with contact areas deposited on the wafer with the active part, can be brought into contact or separated therefrom for thus opening or closing a contact.

FIG. 4a and FIG. 4b depict a schematic view of an example of such a micro relay. Thereby, FIG. 4b exhibits the active systems of the micro relay and FIG. 4a the swiveling platform. Two contact areas 14 and 15 with the leads 16 and 17 are located next to each active system. The hinged plate shows at least on one side contact fingers 18 and 19 which are connected electrically with each other by a lead 20.

If the active system is energized by applying a current to coils 7 and 8, a force on the magnetic flux closure 11, integrated in the swiveling platform is exerted. The platform is thus tilted until the contact fingers and contact areas 14 and 15 are touching each other. Furthermore, in accordance with one embodiment of the invention, the swiveling platform is suspended in a way that, by a tilt of the platform, an additional movement of the contact fingers or the contact bench along the surface of the contact areas is caused. Since the torsion beams 12 and 13 do not only twist during attraction but also bend slightly the two contact points touch, also resulting in a slight lateral movement between the swiveling platform and actuator and therefore between contact fingers and contacts, too. This lateral movement is advantageous and desirable since it can be utilized for scratching off deposited contaminations or developing oxide layers, keeping the contact areas of the contacts 14 and 15 clean.

In FIGS. 4c and 4d, a variation of the design of a micro relay according to FIGS. 4a and 4b is depicted, where FIG. 4d shows the active system of the micro relay and FIG. 4c the swiveling platform. In this variation, the contact fingers are replaced by a contact bench 21. The fundamental function and the build up of the active part depicted in FIG. 4d is otherwise identical with the design shown in FIGS. 4a and 4b.

This invention additionally relates to a microfabricated swiveling platform with one degree of freedom, i.e. it which is tiltable around one axis. It is driven magnetically. The magnet system is designed in a way that the platform is held in its end position by the magnetic force of a hard magnet, thereby defining a detent position. For that reason a current is only required during switching, the detent position is held even without a current supply.

Fabrication Process

The following description of the fabrication process takes reference to PCT EP00/12414 of the same inventor, which was filed on 8-Dec.-2000 and which is titled “Micromechanical tilting device with a magnetic drive and methods for its fabrication”. The disclosure of this application is in full extent subject to the present application by reference, meaning that the whole teaching of this PCT application is included as content of the present application.

FIG. 3 shows an approach for the assembly technique. The whole system is built up on two wafers, which are merged using an appropriate assembly technology. The bottom wafer contains the active part of the magnet system and the top wafer contains the swiveling platform with the flux closure.

Preferably, the material of the bottom wafer may be silicon, ceramic or glass or a combination of these materials. The first fabrication step is the fabrication of the hard magnet. It is deposited by means of liftoff technology, whereby cathode sputtering is applied for the deposition. Next, the fabrication of the yoke is performed. The respective steps are: deposition of a contact layer of magnetic material by means of cathode sputtering, creation of a photo mask, which represents a negative of the magnetic leg structure to be created, electroplating of the leg, stripping the photoresist, and removal of the contact layer by means of ion milling. This process is followed by the deposition of a planarizing insulation layer, for which a photosensitive epoxy is used.

In areas, in which later the poles of the magnet system are to be grown a window is created by means of appropriate photolithography steps.

Next, the dual layer coil is fabricated. The fabrication of the first coil layer as well as of the leads and contact pads is done by means of the following steps:

Deposition of a contact layer of the lead material by means of sputter deposition, creation of a photo mask representing a negative of the coil layer, electroplating of leads and coil layer, stripping of the photoresist, and etching of the contact layer. Next, the coil layer is insulated by means of a photosensitive epoxy. In the areas of the magnetic poles and for creating the vias, i.e. the connections to the next (higher) level, appropriate windows are created in the film.

Afterwards, the vias are fabricated by means of electroplating. Next, the second coil layer is created. The sequence of steps is the same as before. The finished second coil layer is as before covered with an organic, photosensitive insulation layer, which features windows in the area of the magnetic poles. A thickening of the contact pads by means of electroplating, requiring a photo masking for only forming a film on top of the contact pads concludes the coil fabrication. An organic coating embeds the whole system with the exception of the contact pads, which were covered by photoresist.

The completion of the magnetic system is accomplished by electroplating the magnetic poles, followed by a planarization of the wafers. After the planarization, stops are created on top of the poles by means of electroplating. In a final fabrication step, the whole wafer with the exception of the contact pads (they are protected by photoresist) is coated with a passivation layer.

The top wafer is preferable made of silicon, but is covered with a silicon film which serves as a sacrificial layer. On this wafer, as already mentioned, the gimbaled plate and the flux closures are fabricated.

The fabrication of the platform is accomplished by relevant silicon micromechanical processes. First, the sacrificial layer is removed in areas in which the solid state joints of the gimbaled platform are anchored. The fabrication steps are: creation of a photo mask, reactive etching of the silicon and stripping of the photo mask. Next, a film of polycrystalene silicon (polysilicon) is wafer wide deposited, out of which afterwards the solid state joints, the gimbal, and the plate structure are formed. A cavity below the swiveling platform is created in a following step. To do so, the back side of the wafer (in FIG. 3 facing upwards) is masked with a photo mask and the cavity is created by means of anisotropic etching. The next fabrication steps once more occur on the wafer surface (in FIG. 3 facing downwards). The upper flux guide is created, the step sequence is the same as discussed for fabricating the bottom flux guide at the bottom wafer. At the end, by means of photolithography the structure of the torsion spring and the platform is defined and patterned by reactive etching. In case the platform is to serve as a mirror the wafer surface facing up is covered with a reflective material by means of sputter deposition.

In case the swiveling platform shall serve as a mirror, the wafer surface facing up is sputter coated with a reflective material.

Therewith, the wafer process for both wafers is finished. Next is the completion of the whole system by merging the wafers. Due to the required distance between both wafers, rather than bonding the wafers directly to each other, a spacer between them is required.

Merging the three parts (top wafer, spacer, and bottom wafer) is done by means of a bonding process. A dicing process separates the wafer in single systems or arrays.

Preferred Materials

First, the materials of the magnet systems are described. For the magnetic legs, preferably soft magnetic material having a high saturation flux density is used. Possibilities are nickel iron alloys, known as “permalloy”, either in a composition NiFe 81/19, NiFe 45/45, as well as an AlFeSi alloy known as “Sendust”, and NiFeTa. Since nickel iron can be electroplated, it is a preferred material.

The preferred hard magnetic material is SmCo. Also, Co alloys, for instance CoCrTa are suitable. Furthermore, another suitable material is NdFeB. The preferred conductor material for leads and the coil turns is copper, since it shows a lower electromigration than other conductors. However, principally alternative conductor materials may be applied. As insulator materials, anorganic materials like Al2O32 or SiO2 are suitable, they are also useful as passivation layers. Furthermore, organic materials are suitable, too, which are particularly useful, if they may be patterned by photolithography. A photosensitive epoxy with the brand name SU-8 is particularly suitable.

As materials for the swiveling platform, polycrystalline silicon (polysilicon) or silica (SiO2) are particularly suitable—shall the platform serve as a mirror the surface has to be coated with gold or aluminum.

1. A swiveling platform, particularly microtechnically fabricated, having at least one degree of freedom, which is tiltable around at least one axis, wherein the platform is bistably tiltable around two preferably perpendicular axes.

2. (canceled)

3. The swiveling platform as claimed in claim 1, wherein the platform is tiltable due to the influence of magnetic forces.

4. The swiveling platform as claimed in claim 1, wherein the platform has a metal coated reflecting area.

5. The swiveling platform as claimed in claim 1, wherein the platform is gimbaled.

6. The swiveling platform as claimed in claim 1, wherein the platform is locked in a bistable position.

7. The swiveling platform as claimed in claim 1, wherein the platform has a position that is changeable by employment of coils.

8. The swiveling platform as claimed in claim 1, wherein the platform contains a device for closing or opening of a contact.

9. The swiveling platform as claimed in claim 8, wherein the device for closing or opening of a contact contains contact fingers and contact surfaces.

10. The swiveling platform as claimed in claim 8, wherein the device for closing or opening of a contact contains at least one contact bank and contact surfaces.

11. The swiveling platform as claimed in claim 10, wherein the swiveling platform is suspended in a way that a tilting of the platform results in a motion of the contact bank along the surface of said contact surfaces.

12. The swiveling platform as claimed in claim 1, wherein the swiveling platform has a first section and a second section, wherein the first and second sections are connected to each other by joining parts, and wherein the first section comprises a magnetic flux closure.

13. The swiveling platform as claimed in claim 12, wherein the joining parts are opposite with respect to the second section.

14. The swiveling platform as claimed in claim 1, wherein the swiveling platform has a first section and a second section separated from each other by at least one gap.

15. The swiveling platform as claimed in claim 1, wherein the swiveling platform has a stable position at which restoring forces of platform suspensions are minimal by module.

16. The swiveling platform as claimed in claim 9, wherein the swiveling platform is suspended in a way that a tilting of the platform results in a motion of the contact fingers along the surface of said contact surfaces.
